(19) United States
(12) Patent Application Publication
(10) Pub. No.: US 2025/0008986 A1
(43) Pub. Date: Jan. 9, 2025

(54) METHOD FOR PRODUCING PULP-CONTAINING JUICE AND PULP-CONTAINING JUICE PRODUCED THEREBY

(71) Applicant: JADE F&B, Seongnam-si (KR)

(72) Inventors: Jeong Ah LEE, Seongnam-si (KR); Du Hyun KANG, Seongnam-si (KR)

(73) Assignee: JADE F&B, Seongnam-si (KR)

(21) Appl. No.: 18/893,879

(22) Filed: Sep. 23, 2024

Related U.S. Application Data
(63) Continuation-in-part of application No. 17/263,355, filed on Jan. 26, 2021, now abandoned.

(30) Foreign Application Priority Data
Aug. 6, 2019 (KR) 10-2019-0095791

(51) Int. Cl. A23L 2/04; A23L 2/42; A23L 3/015; A23L 3/36; A23L 3/365; B65B 3/00; B65B 55/02

(52) U.S. Cl. CPC A23L 2/04; A23L 2/42; A23L 3/0155; A23L 3/362; A23L 3/365; B65B 3/00; B65B 55/02; B65B 2220/24

(57) ABSTRACT

The present disclosure relates to a method for producing pulp-containing juice, which may produce pulp-containing juice without loss of nutrients while maintaining the flavor and color of a raw material. The method includes squeezing raw material for juice to obtain juice and sterilizing the juice by non-thermal high-pressure processing. Thus, the method may inactivate microorganisms or enzymes, maintain the quality of the juice in a fresh state, and prevent the flavor and nutrients of the raw material from being lost by high-temperature sterilization. In addition, through a quick freezing process, it is possible to prevent the layer separation phenomenon from occurring, prevent the nutrients from being destroyed by temperature changes, and maintain the uniform color of the pulp-containing juice even without using a colorant. A user can conveniently drink the pulp-containing juice produced by this method while feeling the flavor of the fruit thereof without loss of nutrients.

### BACKGROUND

### 1. Technical Field

The present disclosure relates to a method for producing pulp-containing juice, which may produce pulp-containing juice without loss of nutrients while maintaining the flavor and color of a raw material, and pulp-containing juice produced thereby.

### 2. Related Art

With the recent improvement in living standards, modern people's importance in healthy eating has increased, and interest in food ingredients and foods has also increased. Considering these consumer's interests, beverages using various fruits and vegetables have been developed and released in the beverage market. Plants such as fruits and vegetables contain phytochemicals which are produced during plant metabolism in order to prevent the growth of competing plants or protect themselves from various microorganisms and pests. Phytochemicals play a role in giving plants a unique taste, flavor and color to allow the plants to express their own character, and may be roughly divided into phenolic compounds, isoprenoids, betaines, organosulfur compounds, indoles, glucosinolates, organic acids, and the like. When fruits and vegetables containing such phytochemicals are ingested, it is possible to obtain various physiological activities such as reduced cellular oxidative damage, inhibited cancer cell growth, delayed aging, and improved immune function by improving the body's antioxidant function.

In general, beverages using fruits or vegetables are produced by extracting liquid components from fruits or vegetables. In order to improve the physiological activities of phytochemicals while maintaining the flavor and color of the raw materials, these beverages may be produced to contain tissues of fruits and vegetables. Korean Patent Application Publication No. 2016-0041421 discloses a juice production method in which fruit/vegetable juice obtained by mixing and extracting fruits and vegetables is sterilized at a temperature of 115 to 125° C. The production method has problems in that, because fruits and vegetables are exposed to high temperatures, so that the flavor of raw materials is reduced and some nutritional loss is also inevitable. In addition, Korean Patent Application Publication No. 2016-0111893 discloses a Allium tuberosum Rottler drink produced by heating Allium tuberosum Rottlers and then pressing and filtering the heated Allium tuberosum Rottlers, and a method for producing the same. The Allium tuberosum Rottler drink further contains a colorant to control the color change of the drink. However, there is a problem in that consumers who are sensitive to artificial additives are reluctant to select drinks containing such a colorant.

Accordingly, the present inventors have made efforts to overcome the above-described problems, and have developed a method for producing pulp-containing juice, which uses only a raw material without a separate additive and can maintain the taste, flavor, color and nutrients of the raw material even when a sterilization process is performed.

### SUMMARY

An object of the present disclosure is to provide a method for producing pulp-containing juice, the method including: (a) squeezing raw material for juice to obtain juice; (b) filling a container with the juice and then sealing the container to produce a final product; (c) sterilizing the final product by non-thermal high-pressure processing at a pressure of 3,500 to 8,000 bar for 10 to 240 seconds to obtain a sterilized product; and (d) freezing the sterilized product at a temperature of −25 to −45° C. for 6 to 24 hours.

In the method, the raw material in step (a) may be one or more selected from the group consisting of watermelon, orange, calamansi, pineapple, guava, passion fruit, coconut, avocado, purple yam, carrot, and beet.

Step (b) may comprise filtering the juice at least once through a 50 to 300-mesh filter and then filling the container with the filtered juice.

Step (c) may comprise sterilizing the final product by non-thermal high pressure processing at a pressure of 4,000 to 6,000 bar for 60 to 180 seconds.

Step (d) may comprise freezing the sterilized product at a temperature of −30 to −40° C. for 10 to 18 hours.

Another object of the present disclosure is to provide pulp-containing juice produced by the method.

Referring to FIG. 1, a method for producing pulp-containing juice according to one embodiment of the present disclosure may include: (a) squeezing raw material for juice to obtain juice; (b) filling a container with the juice and then sealing the container to produce a final product; (c) sterilizing the final product by non-thermal high pressure processing at a pressure of 3,500 to 8,000 bar for 10 to 240 seconds to obtain a sterilized product; and (d) freezing the sterilized product at a temperature of −25 to −45° C. for 6 to 24 hours.

Hereinafter, steps (a) to (d) of the method will be described in detail.

### (a) Step of Squeezing Raw Material to Obtain Juice

The raw material is not limited as long as it is a fruit or vegetable that may be used for juice production. Examples of the raw material include watermelon, oriental melon, melon, peach, plum, apricot, pear, apple, grape, strawberry, blueberry, cranberry, aronia, Rubus coreanus fruit (Bokbunja), raspberry, mulberry, cherry, mandarin, orange, Citrus junos (Yuja), grapefruit, lemon, lime, calamansi, kiwi, pomegranate, mango, pineapple, papaya, guava, passion fruit, coconut, avocado, tomato, cucumber, beet, spinach, kale, lettuce, celery, cabbage, broccoli, purple yam, carrot, beet, bellflower root, and the like. In the present disclosure, it is preferable to use fruits or vegetables that are rich in pulp and juice and have a good scent and high consumer preference. Specifically, it is possible to use one or more selected from the group consisting of watermelon, orange, calamansi, pineapple, guava, passion fruit, coconut, avocado, purple yam, carrot, and beet.

This raw material may be washed or cut before squeezing. First, the raw material may be washed clean to remove foreign matter and water from the surface thereof, and then cut into an appropriate size to facilitate squeezing. At this time, it is possible to use only the pulp by removing the fruit peel and seed portions unnecessary for juice production.

As a method of squeezing the raw material, any squeezing method known in the art may be used without limitation. For example, the raw material may be squeezed using a juicer such as a hydraulic water pressure juicer, a hydraulic oil pressure juicer or a screw juicer, which squeezes the raw material by applying pressure thereto. Preferably, the raw material may be squeezed using a hydraulic oil pressure juicer at a pressure of 40 to 130 psi. At this time, in order to prevent nutrients such as vitamins and polyphenols contained in fruits or vegetables from being destroyed or denatured by heat, it is preferable that the raw material be squeezed at room temperature or low temperature, and then the juice be stored at low temperature.

(b) Step of Filling Container with Juice and then Sealing Container to Produce Final Product

The juice is in a liquid state separated from fruits or vegetables, and also contains some pulp. If a large amount of pulp in the juice is present in the form of sediment or a floating material, the final juice product may not be soft on the throat during drinking and may not look good visually. For this reason, a filtration method known in the art may be used without limitation in order to remove the solids contained in the juice, and for example, the juice may be filtered using a filter press, a centrifuge, filter paper, a mesh filter, or the like. At this time, in order to increase the filtration efficiency, a 50- to 300-mesh filter is preferably used, and the filtration process may, if necessary, be repeated one or more times.

Since the juice obtained through the filtration process may spoil by temperature changes, the process of filling the container with the juice and sealing the container may be performed at low temperature in order to prevent the juice from spoiling, thereby producing a final product.

### (c) Step of Sterilizing Final Product by Non-Thermal High Pressure Processing

In order to completely inactivate microorganisms or enzymes included in the raw material or introduced during the process of producing the final product, sterilization processing may be performed.

As general food sterilization methods, thermal sterilization methods are used, and may be divided, according to processing temperature, into a low-temperature sterilization method (lower than 70° C.), a high-temperature sterilization method (70° C. or higher), and an high-temperature sterilization method (130° C. or higher). However, some bacteria are known to be resistant to low temperatures, and thus if the final product is sterilized at low temperature, the contents thereof may be decayed due to the propagation of some microorganisms, resulting in a decrease in quality. In addition, if the final product is sterilized at high temperature, heat-vulnerable nutrients (e.g., vitamins, polyphenols, etc.) contained in the product may be destroyed, and thus loss of nutrients is inevitable. In addition, in this case, the thermal process may degrade the flavor of the raw material and result in color changes. In order to solve the problems with such conventional sterilization methods, in the present disclosure, a non-thermal high-pressure sterilization method that applies pressure instead of heat is used. Non-thermal high-pressure sterilization has the advantage of extending the shelf life of the product by inactivating microorganisms or enzymes without heat treatment or preservative treatment while maintaining the freshness, taste, flavor and color of the product. Particularly, the non-thermal high-pressure sterilization may prevent nutrients from being lost by heat.

In the sterilization process, the final product may be sterilized at a pressure of 3,500 to 8,000 bar for 10 to 240 seconds to obtain a sterilized product. At this time, the species of microorganism may be controlled depending on the pressure condition, and the above-described pressure condition is suitable for destroying or inactivating bacteria and viruses such as Vibrio sp., Campylobacter sp. and Escherichia coli, which cause food poisoning. In order to more effectively control the growth and proliferation of pathogenic microorganisms and reduce the loss of nutrients, the final product is preferably sterilized at a pressure of 4,000 to 6,000 bar for 60 to 180 seconds. Since this non-thermal high-pressure sterilization is performed on the final product, it may prevent secondary contamination and prevent the production of compounds or secondary by-products in the product. In addition, the non-thermal high-pressure sterilization maybe performed on a large amount of final products, because the process time thereof is short and the process thereof is simple.

### (d) Step of Quickly Freezing Sterilized Product

The juice of the final product produced in the present disclosure contains pulp, and thus if the juice is left to stand at room temperature for a long period of time, a layer separation phenomenon may occur in which the liquid component and the pulp are separated from each other. In addition, the juice may spoil due to changes in external temperature during storage or distribution. In order to overcome these problems, in the present disclosure, a method of freezing, storing and distributing the final product is used. At this time, the final product is quickly frozen under the freezing conditions of a temperature of −25 to −45° C. for 6 to 24 hours. Quick freezing forms ice crystals with minimal size change by quick passage through the maximum ice crystal formation zone (in the range of −1 to −5° C.), and forms small and uniform ice crystals in the pulp. Accordingly, quick freezing may prevent loss of nutrients, because the plant cells are not destroyed even when the juice with small and uniform ice crystals in the pulp is thawed. In addition, quick freezing may maintain the characteristic color of the plant even without using an artificial colorant. In particular, since ice crystals are formed faster than under normal freezing conditions (−18° C.), the layer separation phenomenon of the juice may be prevented. In order to prevent quality degradation by more effectively controlling the formation rate of ice crystals, the sterilized product is preferably frozen at a temperature of −30 to −40° C. for 10 to 18 hours.

Thereafter, the frozen final product may be stored and distributed under general freezing or refrigeration conditions, and may be thawed at low temperature or room temperature for drinking.

A method for producing pulp-containing juice according to another embodiment of the present disclosure may further comprise steps of quickly thawing the watermelon juice after the step of obtaining the watermelon juice; capturing watermelon flavor after the quick thawing step; and pre-freezing the sterilized product after the sterilizing step by non-thermal high-pressure processing.

### BRIEF DESCRIPTION OF THE DRAWINGS

FIG. 1 is a process diagram showing a method for producing pulp-containing juice according to one embodiment of the present disclosure.

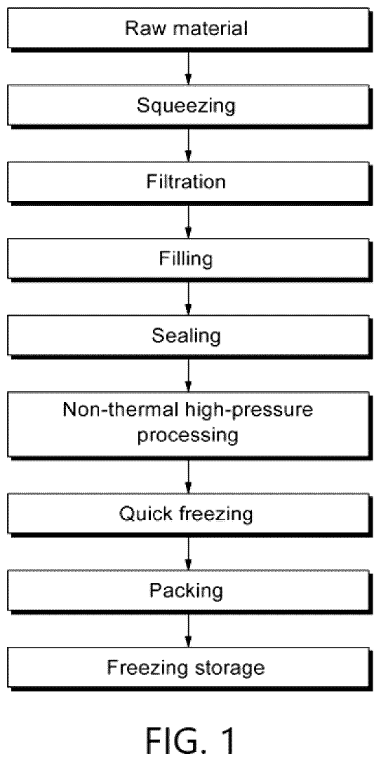

FIG. 2 depicts photographs showing the results of observing the layer separation phenomenon of watermelon juice, produced according to one embodiment of the present disclosure, depending on freezing conditions.

FIG. 3 is a process diagram showing a method for producing pulp-containing juice according to another embodiment of the present disclosure.

FIG. 4 is a schematic diagram illustrating a first pre-freezing portion used in the pre-freezing process among the processes illustrated in FIG. 3.

FIG. 5 is a schematic diagram illustrating a second pre-freezing portion used in the pre-freezing process among the processes illustrated in FIG. 3.

### DETAILED DESCRIPTION

Hereinafter, the method for producing pulp-containing juice according to the present disclosure will be described in more detail with reference to the accompanying drawings. However, this description is provided by way of example only to facilitate the understanding of the present disclosure, and the scope of the present disclosure is not limited by this illustrative description.

### Example 1. Production of Watermelon Juice

A ripe watermelon (produced in Vietnam) was washed in running water to remove foreign matter and then cut. The cut watermelon was squeezed with a hydraulic oil pressure juicer (58 to 116 psi) to obtain watermelon juice from the watermelon pulp. The watermelon juice was filtered through a 100-mesh filter, a PET bottle was filled with the filtered juice and sealed at a temperature of 10° C. or below, and a label (product information and expiration date) was attached to the bottle, thereby producing final watermelon juice. The final watermelon juice was placed in an high-pressure system and sterilized by non-thermal processing at 5,500 bar for 120 seconds. Then, the sterilized watermelon juice was transferred to a freezing warehouse and frozen at −35° C. for 12 hours. The frozen watermelon juice was packed and stored at −18° C. or below.

### Test Example 1. Sensory Test

A sensory test for the watermelon juice of Example 1 and commercially available watermelon juices (Comparative Examples 1 to 3) was performed. The watermelon juice (frozen state) of Example 1 was thawed at room temperature and cold-stored, and the watermelon juices of Comparative Examples 1 to 3 were also cold-stored.
Comparative Example 1: Pulmuone I'm Real Watermelon (containing 90% watermelon juice, coconut juice, and grape concentrate juice)
Comparative Example 2: Tipco Watermelon—watermelon juice (containing 80% watermelon juice, coconut water, purified water, and apple juice concentrate)
Comparative Example 3: H2 Watermelon Juice (containing 100% watermelon)

The sensory test was performed by three panelists for color, taste and flavor based on a five-point scale as shown in Table 1 below.

TABLE 1

| Items | Scoring criteria |
|---|---|
| Color | 1. Good color is scored as 5. |
| | 2. Moderately good color is scored as 4 or 3 depending on |
| | the degree thereof. |
| | 3. Poor color is scored as 2. |
| | 4. Significantly poor color is scored as 1. |
| Taste | 1. Good taste is scored as 5. |
| | 2. Moderately good taste is scored as 4 or 3 depending on |
| | the degree thereof. |
| | 3. Poor taste is scored as 2. |
| | 4. Significantly poor taste, off-taste or off-flavor is |
| | scored as 1. |
| Flavor | 1. Good flavor is scored as 5. |
| | 2. Moderately good flavor is scored as 4 or 3 depending on |
| | the degree thereof. |
| | 3. Poor flavor is scored as 2. |
| | 4. Significantly poor flavor, off-taste or off-flavor is |
| | scored as 1. |

The color, taste and flavor of each watermelon juice were evaluated, and the average scores thereof are shown in Table 2 below.

TABLE 2

| | | Comparative | Comparative | Comparative |
|---|---|---|---|---|
| | Example 1 | Example 1 | Example 2 | Example 3 |
| Color | 5 | 5 | 5 | 5 |
| Taste | 5 | 4 | 4 | 3 |
| Flavor | 5 | 4 | 3 | 3 |

As shown in Table 2 above, it was confirmed that the watermelon juice (Example 1) sterilized by non-thermal processing according to the present disclosure had an excellent taste and flavor by retaining the flavor of watermelon, compared to the watermelon juices (Comparative Examples 1 to 3) produced through thermal processing during processing of the raw materials or products.

Thereafter, the taste and flavor of each cold-stored watermelon juice were evaluated for overall changes over time six times at 2-day intervals, and the average scores thereof are shown in Table 3 below.

TABLE 3

| Run | | Comparative | Comparative | Comparative |
|---|---|---|---|---|
| No. | Example 1 | Example 1 | Example 2 | Example 3 |
| 1 | 5 | 5 | 4 | 4 |
| 2 | 5 | 4 | 4 | 4 |
| 3 | 5 | 4 | 4 | 3 |
| 4 | 5 | 4 | 3 | 3 |
| 5 | 5 | 4 | 3 | 3 |
| 6 | 5 | 4 | 3 | 3 |

As shown in Table 3 above, it was confirmed that the watermelon juice (Example 1) according to the present disclosure maintained constant color and flavor of watermelon even when it was cold-stored for two weeks after thawing, whereas the flavors of the conventional watermelon juices (Comparative Examples 1 to 3) weakened over times.

### Test Example 2. Observation of Layer Separation Phenomenon Depending on Freezing Conditions

During freezing of watermelon juice, temperature- and time-dependent changes were evaluated.

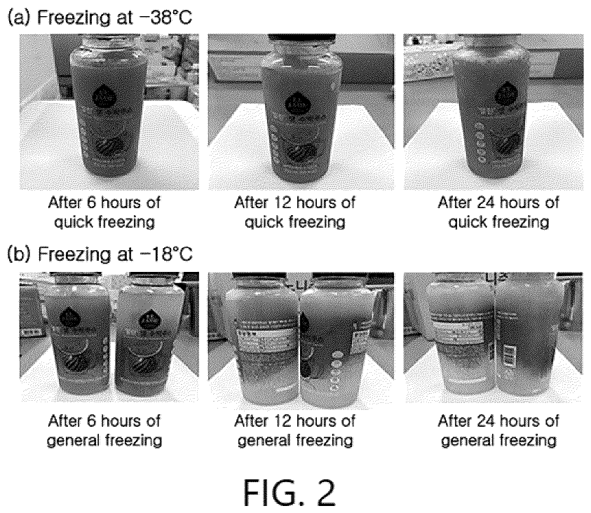

The watermelon juice produced in the same manner as in Example 1 was sterilized and then frozen at each of −38° C. and −18° C. In order to observe whether the watermelon juice was separated into layers during freezing at each temperature, the images of the watermelon juice were captured after 6, 12 and 24 hours of freezing at each temperature, and the results are shown in FIG. 2.

Referring to FIG. 2, it was confirmed that, when the watermelon juice was frozen under the freezing condition (−38° C.) of the present disclosure, the watermelon juice was not separated into layers, and retained the characteristic bright red color of watermelon.

On the other hand, when the watermelon juice was frozen under the general freezing condition (−18° C.), it was confirmed that a layer separation phenomenon appeared due to floating of the pulp in the watermelon juice, and the color of the watermelon juice did not remain uniform. For this reason, in this case, a problem arose in that the commercial value of the watermelon juice was lowered.

### Example 2. Production of Calamansi Juice

Ripe calamansi (produced in Vietnam) was washed in running water to remove foreign matter and then cut. The cut calamansi was squeezed to obtain calamansi juice from the pulp. The calamansi juice was filtered through a 100-mesh filter, a PET bottle was filled with the filtered juice and sealed at a temperature of 10° C. or below, and a label (product information and expiration date) was attached to the bottle, thereby producing final calamansi juice. The final calamansi juice was placed in an high-pressure system and sterilized by non-thermal processing at 5,500 bar for 120 seconds. Then, the sterilized calamansi juice was transferred to a freezing warehouse and frozen at −35° C. for 12 hours. The frozen calamansi juice was packed and stored at −18° C. or below.

### Test Example 3. Physicochemical, Microbial and Sensory Tests

Physicochemical, microbial and sensory tests for the calamansi juice of Example 2 were performed. The calamansi juice (frozen state) of Example 2 was thawed at room temperature and stored at cold temperature (0 to 10° C.) or 15° C. for 9 months. During storage, pH, acidity, microbial and sensory tests for the calamansi juice were performed at 1-month intervals.

The pH was measured using a pH meter, and the acidity was measured according to the acidity measurement method of the Korean Food Standards Codex. The results of the measurement are shown in Table 4 below.

TABLE 4

| | pH | | Acidity | |
|---|---|---|---|---|
| Storage period | 0 to 10° C. | 15° C. | 0 to 10° C. | 15° C. |
| After 1 month | 2.3 | 2.4 | 5.1 | 4.8 |
| After 2 months | 2.4 | 2.4 | 5.1 | 4.8 |
| After 3 months | 2.5 | 2.4 | 5.0 | 4.9 |
| After 4 months | 2.4 | 2.4 | 5.0 | 5.0 |
| After 5 months | 2.4 | 2.4 | 5.1 | 5.1 |
| After 6 months | 2.4 | 2.4 | 5.1 | 5.1 |
| After 7 months | 2.4 | 2.4 | 5.1 | 5.1 |
| After 8 months | 2.4 | 2.4 | 5.1 | 5.1 |
| After 9 months | 2.5 | 2.4 | 5.1 | 5.1 |

In the microbial test, the number of bacterial cells and the number of E. coli cells were counted according to the microbial test method of the Korean Food Standards Codex, and the results are shown in Table 5 below.

TABLE 5

| | Bacterial cell count | | E. coli cell count | |
|---|---|---|---|---|
| Storage period | 0 to 10° C. | 15° C. | 0 to 10° C. | 15° C. |
| After 1 month | 0, 0, 0, 0, 0 | 0, 0, 0, 0, 0 | 0, 0, 0, 0, 0 | 0, 0, 0, 0, 0 |
| After 2 months | 0, 0, 0, 0, 0 | 0, 0, 0, 0, 0 | 0, 0, 0, 0, 0 | 0, 0, 0, 0, 0 |
| After 3 months | 0, 0, 0, 0, 0 | 0, 0, 0, 0, 1 | 0, 0, 0, 0, 0 | 0, 0, 0, 0, 0 |
| After 4 months | 0, 1, 0, 0, 0 | 0, 0, 0, 0, 0 | 0, 0, 0, 0, 0 | 0, 0, 0, 0, 0 |
| After 5 months | 0, 0, 0, 0, 0 | 0, 0, 0, 0, 0 | 0, 0, 0, 0, 0 | 0, 0, 0, 0, 0 |
| After 6 months | 0, 0, 0, 0, 0 | 0, 0, 0, 0, 0 | 0, 0, 0, 0, 0 | 0, 0, 0, 0, 0 |
| After 7 months | 0, 0, 0, 0, 0 | 0, 0, 0, 0, 0 | 0, 0, 0, 0, 0 | 0, 0, 0, 0, 0 |
| After 8 months | 0, 0, 0, 0, 0 | 0, 0, 0, 0, 0 | 0, 0, 0, 0, 0 | 0, 0, 0, 0, 0 |
| After 9 months | 0, 0, 0, 0, 0 | 0, 0, 0, 0, 0 | 0, 0, 0, 0, 0 | 0, 0, 0, 0, 0 |

The sensory test was performed by three panelists for changes in the appearance and sediment of the calamansi juice. For the sensory test, the limit value of the product level was set to 5 based on a limit sample level of 9, and the changes were evaluated. The average scores are shown in Table 6 below.

TABLE 6

| | Appearance | | Sediment | |
|---|---|---|---|---|
| Storage period | 0 to 10° C. | 15° C. | 0 to 10° C. | 15° C. |
| After 1 month | 9 | 8 | 8 | 8 |
| After 2 months | 8 | 8 | 8 | 8 |
| After 3 months | 8 | 8 | 7 | 7 |
| After 4 months | 7 | 7 | 7 | 7 |
| After 5 months | 7 | 7 | 6 | 6 |
| After 6 months | 6 | 6 | 6 | 6 |
| After 7 months | 6 | 6 | 5 | 5 |
| After 8 months | 6 | 5 | 5 | 5 |
| After 9 months | 5 | 5 | 5 | 5 |

As shown in Tables 4 to 6 above, it was confirmed that the pH, acidity, appearance and sediment of the calamansi juice (Example 2) sterilized by non-thermal processing according to the present disclosure did not change even when it was stored under the severe condition (15° C.). In addition, it was confirmed that less than acceptable levels of microorganisms were detected in the calamansi juice, indicating that the quality of the calamansi juice is maintained for a long period of time.

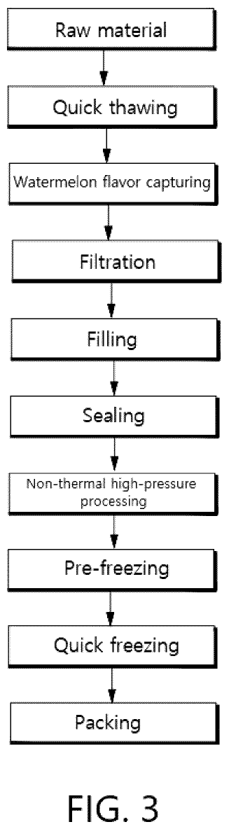

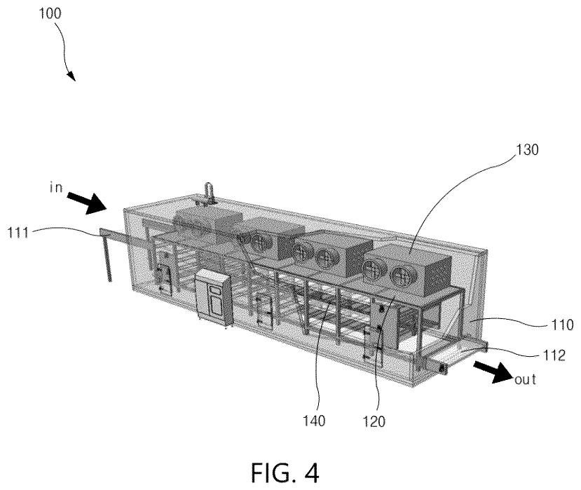

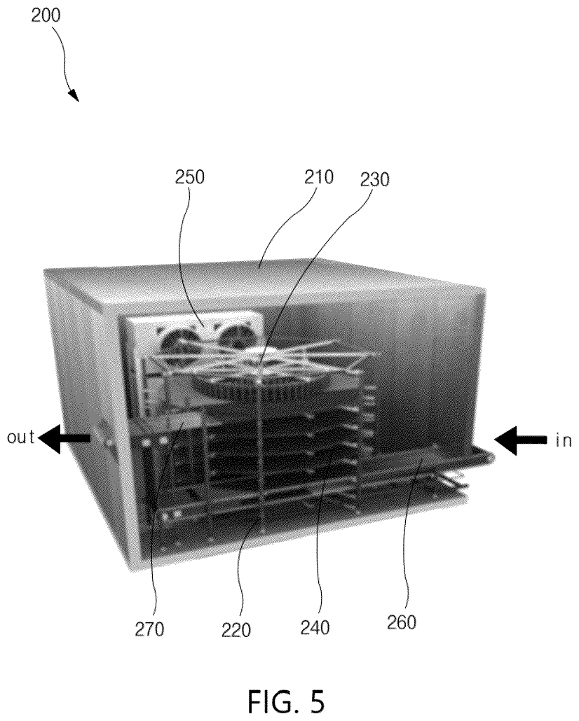

FIG. 3 is a process diagram showing a method for producing pulp-containing juice according to another embodiment of the present disclosure. FIG. 4 is a schematic diagram illustrating a first pre-freezing portion used in the pre-freezing process among the processes illustrated in FIG. 3. FIG. 5 is a schematic diagram illustrating a second pre-freezing portion used in the pre-freezing process among the processes illustrated in FIG. 3.

A method for producing puldp-containing juice according to another embodiment of the present disclosure is different from the method according to the above-described embodiment in that the method provides a quick thawing process and a watermelon flavor ctaapturing process after the processes for raw material among the above-described processes, and provides a pre-freezing process after the non-thermal high-pressure processing.

The method for producing pulp-containing juice according to according to an embodiment of the present disclosure may comprise thawing a watermelon raw material, followed by quickly thawing in a crusher (ICE CRUSHER), to maintain the unique taste, aroma, color and nutritional components of watermelon. In such step, the rotation speed of the crusher may be set to 10 to 40 rpm to quickly thaw the raw material.

### Test Example 4. Sensory Tests According to Speed of Grinder

Sensory tests were performed to determine changes in flavor and texture according to the speed of the grinder applied to an embodiment of the present disclosure.

TABLE 7

| | Grading Criteria |
|---|---|
| Flavor | 1. One having a good flavor is given 5 points. |
| | 2. One having a generally good flavor is given 4 or 3 |
| | points depending on the degree. |
| | 3. One having a bad flavor is given 2 points. |
| | 4. One having a significantly bad flavor or already |
| | having an off-flavor is given 1 point. |
| Taste | 1. One having a good taste is given 5 points. |
| | 2. One having a generally good taste is given 4 or 3 |
| | points depending on the degree. |
| | 3. One having a bad taste is given 2 points. |
| | 4. One having a significantly bad taste or already |
| | having an off-flavor is given 1 point. |

TABLE 8

| | Sensory Tests | | |
|---|---|---|---|
| Speed of ICE | | Taste | |
| CRUSHER | Flavor | (texture) | Thawing time |
| 10 RPM | 3 | 5 | 70 minutes |
| 15 RPM | 4 | 5 | 50 minutes |
| 20 RPM | 5 | 5 | 35 minutes |
| 25 RPM | 5 | 5 | 30 minutes |
| 30 RPM | 5 | 5 | 25 minutes |
| 35 RPM | 5 | 4 | 20 minutes |
| 40 RPM | 5 | 3 | 15 minutes |

As shown in Table 8 above, at an appropriate RPM of 15 or less, it took a long time for the watermelon raw material to thaw, resulting in a weak sensory flavor, and, at an RPM of 35 or more, the texture of the watermelon was reduced. The most appropriate RPM may be 20 to 30 RPM, and the most appropriate thawing time may be less than 35 minutes.

A method according to an embodiment of the present disclosure may remove dissolved gases from watermelon juice in a vacuum state to improve product quality, flavor and nutrients.

A method according to an embodiment of the present disclosure may comprise connecting a vacuum tube capable of evaporation at a low temperature immediately after thawing watermelon to capture heat-sensitive watermelon flavor components without damage. At this time, the vacuum pressure may be 0.04 to 0.08 mpa.

A method according to an embodiment of the present disclosure may perform a pre-freezing step of maintaining a sterilized watermelon juice product at a preset temperature or temperature range. At this time, in the pre-freezing step, the sterilized juice product may be pre-frozen at −20 to −50° C. for 10 to 40 minutes by means of a first pre-freezing portion or a second pre-freezing portion to maintain the product temperature of the sterilized juice product at −4 to −6° C. In addition, the product temperature of the sterilized juice product may be maintained at −5° C. through the pre-freezing.

In more detail, the juice of the juice product produced according to an embodiment of the present disclosure contains pulp, and, thus, if left at room temperature for a long period of time, the juice may undergo a layer separation phenomenon in which the liquid component and pulp are separated, and the juice may deteriorate due to changes in the external temperature during storage or distribution.

In addition, slow freezing delays the time required to pass through the maximum ice crystal formation zone, resulting in the creation of large, uneven ice crystals. When products frozen in such way are thawed, the cell membranes are destroyed, resulting in a significant deterioration in the texture and taste of the food.

To solve such problems, a method according to an embodiment of the present disclosure comprises pre-freezing a sterilized juice product at −20 to −40° C., followed by passing through a maximum ice crystal formation zone in a short period of time, to form small and uniform ice crystals such that, even when the juice product is thawed, the cell shape is maintained, and the original flavor, color and aroma are maintained.

At this time, the pre-freezing in the pre-freezing step may be performed by using quick freezing methods such as a tunnel method and a spiral method. Using the tunnel method, pre-freezing may be performed at −25 to −40° C. for 30 to 40 minutes.

In addition, the pre-freezing may comprise a cooling device comprising a tunnel structure of 20 to 40 m and a spiral structure of 20 to 40 m.

The tunnel structure applied to an embodiment of the present disclosure may be the first pre-freezing portion 100 illustrated in FIG. 4.

The first pre-freezing portion 100 may be of a tunnel type, which is suitable when the installation space needs to be reduced, and the juice product to be pre-frozen may be fed into the upper part and then discharged from the lower part.

A first pre-freezing portion 100 according to an embodiment of the present disclosure comprises, as shown in FIG. 4, a first freezing body 110 having an elongated rectangular prism shape, a first support 120 arranged inside the first freezing body 110, a plurality of first cold air supply portions 130 arranged on the first support 120 to provide cold air to the juice product, and a first transport conveyor 140 configured to transport the juice product introduced into the interior of the first freezing body 110 through the first inlet 111 of the first freezing body 110 to the first outlet 112 of the first freezing body 110.

A juice product according to an embodiment of the present disclosure is introduced into the interior of the first freezing body 110 through the first inlet 111 illustrated in FIG. 4, and the juice product pre-frozen in the first freezing body 110 may be discharged to the exterior of the first freezing body 110 through the first outlet 112.

A first transport conveyor 140 according to an embodiment of the present invention is provided in multiple layers such that the juice product transported by means of the first transport conveyor 140 may secure sufficient pre-freezing time.

The spiral structure applied to an embodiment of the present disclosure may be the second pre-freezing portion illustrated in FIG. 5.

A second pre-freezing portion 200 according to an embodiment of the present disclosure comprises, as shown in FIG. 5, a second freezing body 210, a plurality of second supports 220 arranged inside the second freezing body 210, a rotating support shaft 230 rotatably coupled to the inside of the second freezing body 210, a rotating body 240 configured to be coupled to the rotating support shaft 230 and rotate together with the rotating support shaft 230 to transport the juice product, a second cold air supply portion 250 coupled inside the second freezing body 210 to supply cold air to the rotating body 240, a second transport conveyor 260 arranged in the second freezing body 210 to transport the juice product to the rotating body 240, and a third transport conveyor 270 arranged in the second freezing body 210 to discharge the juice product supplied from the rotating body 240 to the outside of the second freezing body 210.

The rotating body 240 according to an embodiment of the present disclosure may have a multi-layered spiral structure in which the left direction is low and the right direction is high, as illustrated in FIG. 5. Accordingly, the juice product transported by means of the second transport conveyor 260 may move to the rotating body 240 through the lowest layer of the rotating body 240 arranged close to the second transport conveyor 260, and the juice product to which the supply of cold air is completed may move to the third transport conveyor 270 through the highest layer of the rotating body 240.

As described above, the method for producing pulp-containing juice according to the present disclosure includes squeezing raw material for juice to obtain juice and sterilizing the juice by non-thermal high-pressure processing. Thus, the method may inactivate microorganisms or enzymes, maintain the quality of the juice in a fresh state, and prevent the flavor and nutrients of the raw material from being lost by high-temperature sterilization. In addition, through the quick freezing process, it is possible to prevent the layer separation phenomenon from occurring, prevent the nutrients from being destroyed by temperature changes, and maintain the uniform color of the pulp-containing juice even without using a colorant.

A user can conveniently drink the pulp-containing juice produced by this method while feeling the flavor of the fruit thereof without loss of nutrients.

A method according to an embodiment of the present disclosure comprises quickly thawing the raw material in a short period of time to maintain the unique flavor of watermelon and minimize flavor loss, thereby improving product quality.

In addition, the method may capture heat-sensitive watermelon flavor components without damage during storage after thawing, thereby maintaining the original flavor and aroma of watermelon juice.

Moreover, the method comprises pre-freezing a sterilized juice product, followed by passing through a maximum ice crystal formation zone in a short period of time, to form small and uniform ice crystals, thereby maintaining the shape of the cells and retaining the original flavor, color and aroma.

### DESCRIPTION OF REFERENCE NUMERALS

100: First pre-freezing portion
110: First freezing body
111: First inlet
112: First outlet
120: First support
130: First cold air supply portion
140: First transport conveyor
200: Second pre-freezing portion
210: Second freezing body
220: Second support
230: Rotating support shaft
240: Rotating body
250: Second cold air supply portion
260: Second transport conveyor
270: Third transport conveyor

What is claimed is:

1. A method for producing pulp-containing juice, the method comprising:
(a) squeezing raw material for juice to obtain juice;
(b) filling a container with the juice and then sealing the container to produce a final product;
(c) sterilizing the final product by non-thermal high-pressure processing at a pressure of 3,500 to 8,000 bar for 10 to 240 seconds to obtain a sterilized product;
(d) freezing the sterilized product at a temperature of −25 to −45° C. for 6 to 24 hours, ensuring that a layer separation between the liquid component and pulp of the watermelon juice does not occur during the process of freezing the product in step (d);
(e) quickly thawing the watermelon juice after the step of obtaining the watermelon juice;
(f) capturing watermelon flavor after the quick thawing step; and
(g) pre-freezing the sterilized product after the sterilizing step by non-thermal high-pressure processing.

2. The method of claim 1, wherein the pre-freezing step is performed by a first pre-freezing portion, and
the first pre-freezing portion comprises:
a first freezing body;
a first support arranged inside the first freezing body;
a plurality of first cold air supply portions arranged on the first support to provide cold air to the sterilized product; and
a first transport conveyor configured to transport the sterilized product introduced into the interior of the first freezing body through a first inlet of the first freezing body to a first outlet of the first freezing body.

3. The method of claim 1, wherein the pre-freezing step is performed by means of a second pre-freezing portion, and
the second pre-freezing portion comprises:
a second freezing body;
a plurality of second supports arranged inside the second freezing body;
a rotating support shaft rotatably coupled to the inside of the second freezing body;
a rotating body configured to be coupled to the rotating support shaft and rotate together with the rotating support shaft to transport the sterilized product;
a second cold air supply portion coupled inside the second freezing body to supply cold air to the rotating body;
a second transport conveyor arranged in the second freezing body to transport the sterilized product to the rotating body; and
a third transport conveyor arranged in the second freezing body to discharge the sterilized product supplied from the rotating body to the outside of the second freezing body.

4. Pulp-containing watermelon juice produced by the method of claim 1.
